(19) United States
(12) Patent Application Publication
(10) Pub. No.: US 2016/0000042 A1
(43) Pub. Date: Jan. 7, 2016

(54) Pet Fence Device, System and Method

(71) Applicant: BLU ANGEL LLC, Lake Forest, IL (US)

(72) Inventor: Adam Smith, Olmsted Twp., OH (US)

(73) Assignee: BLU ANGEL LLC, Lake Forest, IL (US)

(21) Appl. No.: 14/321,969

(22) Filed: Jul. 2, 2014

(51) Int. Cl. A01K 15/02; G08B 1/08; A01K 15/04

(52) U.S. Cl. CPC A01K 15/023; A01K 15/04; G08B 1/08

(57) ABSTRACT

An electronic fence system including a transmitter, an antenna cable for virtually enclosing an area for an animal, such as a pet, and a receiver collar for providing a warning or correction so the animal stays within the enclosed area is disclosed. The cable may have lights for alerting the pet to the boundary of the enclosed area. The transmitter may be mounted to a reel for holding and transporting the antenna cable. The system can also have a remote monitor to inform the user that the animal may have left the enclosed area. Preferably the lights on the cable flash when the animal is too close to the boundary. Methods using the electronic fence system are also disclosed.

### FIELD OF THE INVENTION

The present invention relates to animal containment systems and their method of use.

### BACKGROUND OF THE INVENTION

Pet fences generally refer to a virtual or electronic fence for keeping a pet within a designated area without a fence that physically confines the pet to the area. Typically, the pet wears a collar which administers corrections to the pet if it approaches the edge of the designated area.

The collar may administer an audible correction. However, audible corrections are not useful for deaf animals.

The collar may administer a static electricity (shock) correction, also known as a static correction. Some pet owners are concerned that such static corrections are cruel to the pet. More importantly, collars administering static corrections have electrodes that cannot be continuously worn by a pet due to irritation and the possibility of infection from the electrodes “digging” into the pet's skin.

Some pets are difficult to train so that they remain in the designated area due to temperament, deafness, bad memory, etc.

Electronic pet fences also can be inconvenient in use. For example, there are often occasions when the pet is permitted to leave the designated area. If a user does not remove the collar, a pet may not want to leave the designated area for fear of receiving a correction from the collar. Even worse, an owner may forget to turn off the pet fence or is unable to do so and the pet receives an uncomfortable correction or learns that it can cross the fence without a correction.

Popular electronic pet fences provide corrections to a pet, but if the pet leaves the designated area, the pet will receive corrections if it tries to return to the designated area. Also, if a pet leaves the designated area, an owner will likely be unaware that the pet has left the designated area until he or she notices that the pet is missing. Consequently, the pet could travel a long distance before the owner notices that the pet is missing.

Conventional electronic pet fences are not readily transportable and easy to set up for taking a pet to a park or taking a pet on vacation. Even if such a fence could theoretically be transportable, such a pet fence would not be very effective because a pet still needs to learn what the designated area is. If a pet is staying in different locations, while on vacation for example, the designated area for the pet may also change daily and the pet may never learn what the designated area is, causing further stress for the animal.

In view of the foregoing, there exists a need for an improved pet fence.

### SUMMARY OF THE INVENTION

In accordance with one aspect of the present invention, a portable electronic fence system is provided for enclosing an area to prevent an animal carrying a signal receiver from either leaving (if the animal is located within the area) or entering (if the animal is outside of the area) the area, which provides a warning to the animal when the animal is too close to the electronic fence. The fence system includes an antenna cable for enclosing the area, and a transmitter for transmitting a signal to the receiver through the antenna. The antenna has a length and typically a plurality of lights spaced along the length. In typical use, the antenna is merely laid upon the surface of the area to be enclosed or is otherwise located slightly above the surface of the area to be enclosed, which can be accomplished by suitable antenna supports. Consequently, the area can be easily enclosed to provide the desired restricted area for the pet, either for preventing the pet from leaving the restricted area or for preventing the pet from entering the restricted area.

The fence system may also include a carrier including an antenna cable storage reel, the transmitter mounted to the carrier. The antenna cable storage reel may have a core and a shaft around which the reel core can be rotated for winding the antenna cable around the core.

The fence system may also include a flashing mode control wherein the plurality of lights are flashed by operation of the flashing mode control. The fence system may also include a portable device having the receiver and a second transmitter for transmitting a second signal for activating the flashing mode control. The transmitter may be part of a base device, which also has a second receiver for receiving the second signal. The fence system may also have a remote control having a transmitter for transmitting a signal to the base device to turn off the transmitter, a third receiver for receiving the second signal, and an indicator for making an indication that the animal has received the warning. The indicator is operatively connected to the receiver to make the indication responsive to the receipt of the second signal by the receiver.

The antenna cable may have a power conductor for supplying power to the lights and a signal conductor for transmitting the signal. The fence system may also include the signal receiver.

In accordance with another aspect of the present invention, a portable electronic fence system is provided for enclosing an area to prevent an animal carrying a signal receiver from either entering or leaving the area, which provides a warning to the animal when the animal is too close to the electronic fence. The fence system includes an antenna cable for enclosing the area, a transmitter for transmitting a signal to the receiver through the antenna, and a carrier for the antenna cable. The carrier includes an antenna cable storage reel and the transmitter is mounted to the carrier. Typically, the reel includes a core and a shaft around which the reel can be rotated for winding the antenna cable around the core. A battery for supplying electricity to the transmitter may be mounted to the carrier.

In accordance with another aspect of the present invention, a portable device for attaching to an animal and keeping the animal either within or out of an area enclosed by an antenna cable connected to a base unit is provided. The portable device includes a receiver for receiving a first signal transmitted by the antenna cable, a warning generator for issuing a first warning to the animal when the first signal received by the receiver meets or exceeds a first threshold, and a transmitter for transmitting a second signal to the antenna cable for triggering a second warning to the animal by the base unit, wherein the second signal is transmitted responsively to the receipt of the first signal at or above a second threshold. Typically, the first warning is an audible warning, an electric shock, or a vibration. Preferably, the portable device has an adjustable strap for attaching the portable device to the animal. Typically, the portable device has a light, which lights in response to receipt of the first signal by the receiver above a third threshold, for making the animal easier to locate. Typically, the warning generator generates a third warning in response to receipt of the first signal by the receiver above a third threshold, the third warning being an electric shock or a vibration.

In accordance with another aspect of the present invention, a method of keeping an animal within an enclosed area is provided. The method includes enclosing an area with an antenna cable including a plurality of lights, transmitting a signal through the antenna cable while the animal is in the enclosed area to a receiver carried by the animal; and illuminating the antenna cable with the lights. In a further aspect, the method includes placing a deaf animal into the area.

Typically, the method includes transmitting a second signal from a transmitter carried by the animal and flashing the lights responsive to receipt of the second signal above a threshold. The method may include lighting the lights continuously while transmitting the signal except when flashing the lights.

Typically, enclosing the area includes unwinding the antenna cable from a reel, and prior to the enclosing the area, and the method may include carrying the reel to the area, the antenna cable or a portion thereof being wound around the reel during the carrying.

Typically, the method includes enclosing a second area with the antenna cable and transmitting the signal through the antenna cable while the animal is in the second enclosed area. The method may also include winding the antenna cable onto a reel, a transmitter for transmitting the signal mounted to the reel, carrying the reel with the antenna cable wound around the reel from the (first) area to the second area; and unwinding the antenna cable from the reel during the enclosing of the second area.

The method may also include placing a plurality of supports around the area and placing the antenna cable onto the supports for raising the antenna cable off the ground during the enclosing. More preferably, the animal is trained to stay within the area enclosed by the raised antenna cable.

The method can be used to enclosed an area that is already partially enclosed by a physical barrier, for example, a wall or barrier that the animal cannot pass through, such as the walls of a room, a physical animal-barrier, fence or other physical animal barrier for the particular type of animal under consideration. For example, a conventional chain link fence would be a barrier to most if not all dogs, but a chicken wire fence may not be depending on the type of chicken wire and the size of the dog. Thus, the antenna need not enclose any portions of the area that are enclosed by a physical barrier. Thus, embodiments of the invention can be particularly suited to enclosing an area partially enclosed by a physical barrier to the animal, a room of a home having an open doorway using a length of antenna cable that spans the width of the open doorway or portion of it that is open. Consequently, “enclosing an area” as used herein does not necessarily require that the antenna cable completely encircle or encompass the area to be enclosed—only those portions of the perimeter of the area that do not already present a barrier to the animal without the antenna cable.

In accordance with another aspect of the present invention, a remote monitor for monitoring whether an animal has received a warning is provided. The monitor includes a receiver for receiving a signal indicative of a warning having been made to an animal and an indicator for making an indication that the animal has received the warning. The indicator is operatively connected to the receiver to make the indication responsive to the receipt of the second signal by the receiver. The indication may be audible, vibratory, visual or combinations thereof. Preferably, the remote monitor includes a transmitter for transmitting a signal to the base device to turn off an electric fence containing the animal.

In accordance with another aspect of the present invention, an antenna cable has a plurality of lights, a power conductor for supplying power to the lights, and a signal conductor for transmitting a signal. The antenna cable may be flat. The lights may be grouped into groups and the groups are regularly spaced along the cable. The cable may also have a termination device at one end of the cable. The cable may be wound around a reel.

In accordance with another aspect of the invention, a device and method of keeping an animal either within or outside of a room having an open doorway is provided. The device includes a relatively short antenna cable, typically less than 9 feet in length, such as 3, 4, 5, 6, 7 or 8 feet in length, a transmitter to transmit a signal through the antenna and a receiver to be worn by the animal. The method includes keeping an animal either within or outside of a room having an open doorway comprising laying an antenna cable across the doorway, and transmitting a signal through the antenna cable while the animal is in the enclosed area to a receiver carried by the animal.

The invention in its various aspects provides solutions to the needs identified in the background.

### BRIEF DESCRIPTION OF THE FIGURES

The accompanying drawings form part of the specification and like numerals are employed to designate like parts throughout the same.

FIG. 1 is a schematic view of one embodiment of a system according to the invention in an outdoor setting configured for typical use.

FIG. 2 is a schematic view of the embodiment of FIG. 1 configured for training use.

FIG. 3 is a front elevation view of a base device of the system of FIG. 1 with a cover flipped up.

FIG. 4 is a perspective view of two cables for use in the system of FIG. 1.

FIG. 5 is a cross-section of one of the cables of FIG. 4.

FIG. 6 is a magnified view of a support used in the configuration of the embodiment of the system of FIG. 2.

FIG. 7 is a perspective view of a first portable device to be worn or carried by a pet for use with the system according to FIG. 1 or 2.

FIG. 8 is a block diagram of a second portable device to be worn or carried by a pet for use with the system of FIG. 1 or 2.

FIG. 9 is a block diagram of a remote monitor for use with the system of FIG. 1 or 2.

FIG. 10 is a schematic view of a second embodiment of a system according to the invention for use in blocking passages and doorways.

FIG. 11 is a perspective view of a first embodiment of a termination device at the end of a cable used in the system of FIG. 10.

FIG. 12 is a perspective view of a second embodiment of a termination device at the end of a cable used in the system of FIG. 10.

### DETAILED DESCRIPTION OF THE INVENTION

While this invention is susceptible of embodiment in many different forms, there is shown in the drawings and described in detail herein, several specific embodiments with the understanding that the present disclosure is to be considered as exemplifications of the principles of the invention and is not intended to limit the invention to the embodiments illustrated. For example, the invention is discussed with reference to a pet P, an animal, but the invention may be used more generally with animals.

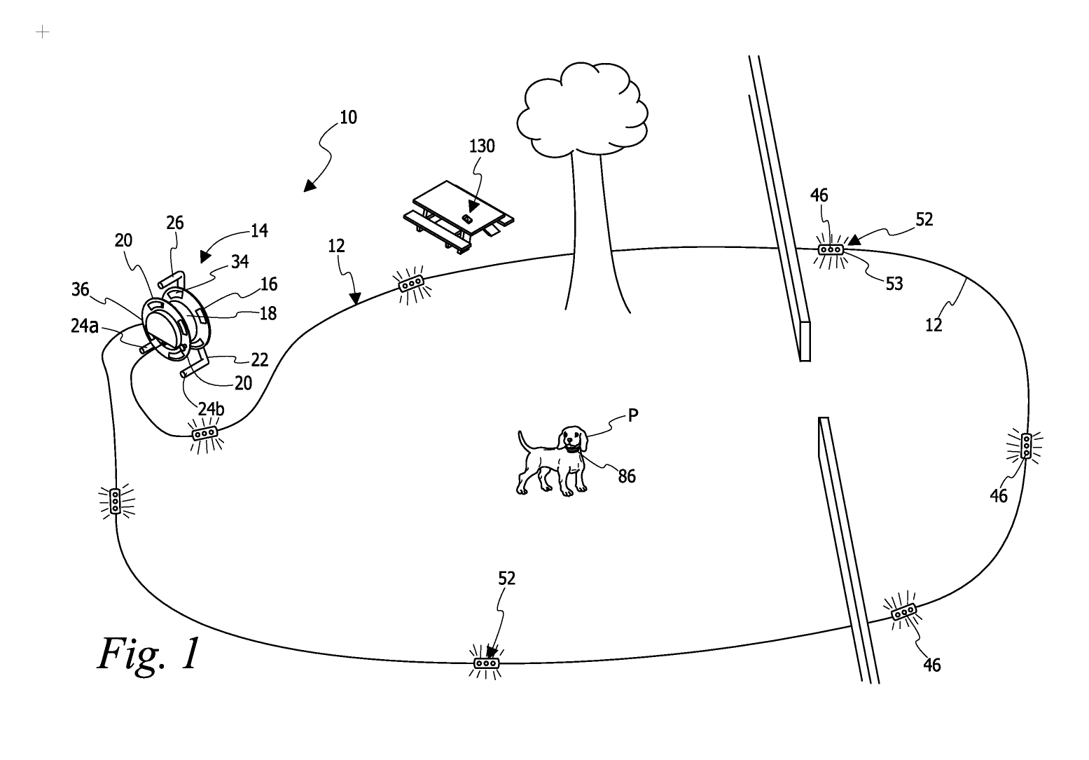

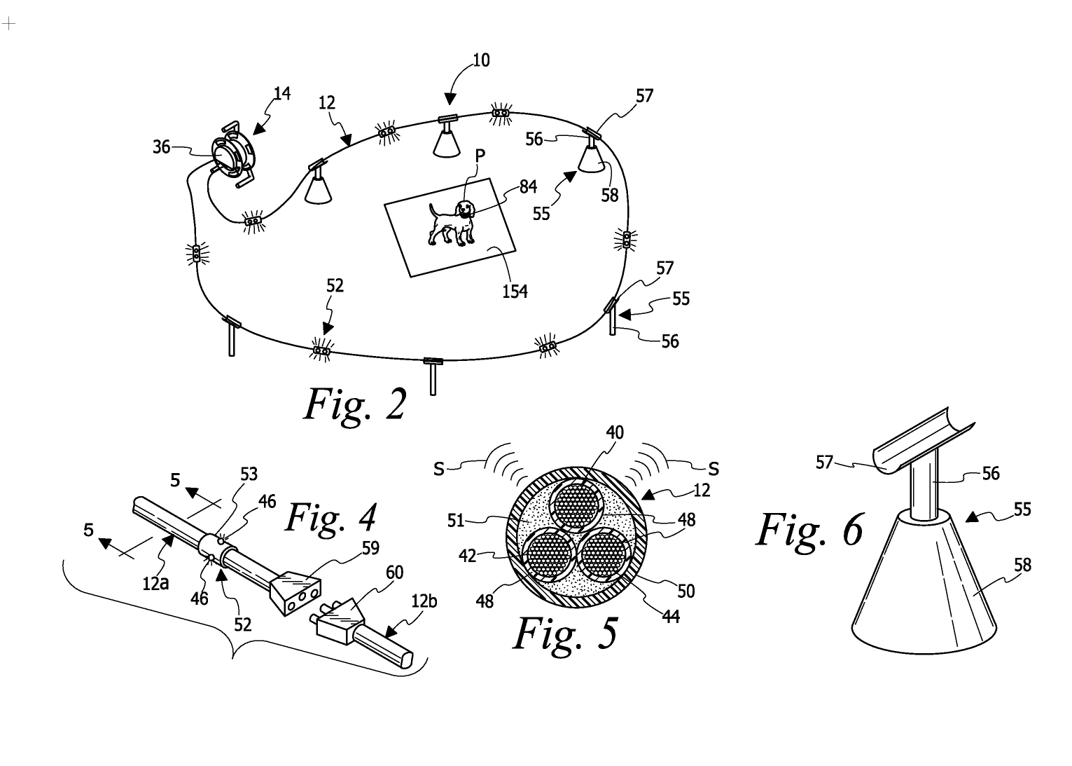

Referring to the FIGS. 1 and 2, an electronic fence system 10 is illustrated. Fence system 10 has an antenna cable 12 and a base or transmitter device 14, which is preferably mounted to a reel 16. Reel 16 includes a core 18, walls 20, and stand 22. Stand 22 has legs 24a and 24b, a carrying handle 26, and a shaft around which core 18 is pivotally mounted. One or both walls 20 may have handles for rotating reel 16 around the shaft. The handles may be in the form of a lever, knob 32 or voids 34 in walls 20. Base device 14 may also have a cover 36 for covering a control panel 62.

Antenna cable 12 includes a signal or first conductor 40, a power or second conductor 42, and a plurality of lights 46 spaced along the length of cable 12. Cable 12 may optionally have a third conductor 44 and additional conductors also for power. First conductor 40 serves as an antenna for base device 14. Second conductor 42 supplies electrical power to lights 46. All lights 46 can be connected in series in which case conductor 44 is unnecessary. A third conductor 44 can be used for connecting lights 46 in parallel or signal conductor 40 can also be used for power. Alternatively, second conductor 42 supplies power to half of lights 46 while third conductor 44 can be used for supplying power to the other half of lights 46 preferably interspersed so that breakage of a light 46 connected in series does not result in large sections of antenna cable 12 being unlit. Power conductors may be positive or negative in DC systems, or live or neutral in AC systems. Cable 12 has an exterior insulating flexible sheath 50 around all the conductors in the cable and each conductor 40, 42, and 44 typically has its own insulating flexible sheath 48 to prevent conductors 40, 42, and 44 from touching. Conductors 40, 42 and 44 typically extend along the entire length of cable 12. Sheath 50 may be translucent or transparent and lights 46 may be contained within sheath 50. The sheaths are typically made of a durable flexible plastic, while the conductors are made from suitable conducting materials such as copper, aluminum and combinations thereof. The cable may include an electrically insulating and flexible filler 51 for giving the cable a round cross-section. The resulting cable 12 is flexible and can be readily wound on a spool or reel.

Where the lights 46 are directional, such as typical LED lights, lights 46 may be grouped into groups 52 of 2, 3 or more lights 46 to ensure that no matter how antenna cable 12 is laid out one of the lights 46 of a group 52 is visible regardless of viewing angle. Directional lights 46 are preferably oriented at approximately 90 degrees relative to the direction of cable 12 around group 52 and approximately evenly distributed angularly relative to each other (at about 180 degrees for 2 directional lights 46 within a group and at about 120 degrees for 3 directional lights 46 within a group 52 as in FIG. 4 which shows 2 of 3 lights). Lights 46 within a group 52 may be staggered in the length dimension of the antenna cable. With each group 52, there is typically a resistor whose selection can be made according to known principles based on the characteristics of the lights 46 and the voltage when lights 46 are LEDs. Lights 46 within a group 52 may be wired serially or in parallel. Lights 46 or groups 52 are spaced along the length of antenna cable 12, preferably regularly spaced about every 1 to 5 feet, more preferably about every 1.5 to 3 feet, even more preferably about every 20 to 30 inches, and most preferably about every 24 inches. Lights 46 may be any suitable lights including incandescent, halogen, fluorescent and LED (light emitting diode) and typically will be low voltage lights, such as 12 volts or less, for example. Lights 46 may be located within housings 53 or within the sheath 50, if the sheath is translucent. Each group 52 may be contained within a separate housing 53. Housing 53 is preferably cylindrical, transparent, of hard plastic or rubber, and of approximately the same diameter as cable 12. Lights 46 may shine white, yellow, amber, orange, red, blue-violet or any suitable color. Sheaths 48 and 50 may be any suitable color including those suitable for lights 46. If sheath 50 is translucent, sheaths 48 preferably have a color from the colors indicated for lights 46. Blue-violet is a preferred color for lights 46 and sheaths 48 and 50 because it is particularly visible to canines, is not likely to match the color of the surfaces on which antenna cable 12 is likely to be placed on, and is less stimulating to people, especially at night.

Antenna cable 12 is elongated, having a desired length which, depending on the nature of the intended use, may be about 50 feet or more or less in length, alternatively at least 75 feet in length, and even between about 90 feet and 250 feet in length, for example. Antenna cable 12 may be composed of several lengths of cable, for example, 12a and 12b as shown in FIG. 4. Cable 12a may be sold with a complete fence system 10 and cable 12b may be sold separately as an extension cable. Alternatively, for internal home or other use in a building where it is desired to restrict the animal to one room having one open doorway, or to prevent access to that one room, the antenna cable need only be about the length of one doorway. Similarly, if the room has more than one doorway, the antenna length generally would be sufficient to span across both doorways and a length therebetween. Thus, for a home use or in building embodiment, the length of the antenna cable may be relatively short, such as 3′, 6′, 9′ or more, for example. In that case, a reel is not required and the cable can be simply plugged in to an antenna input of the control device.

Cable 12 may be used with supports 55 to raise cable 12 off the ground. Supports 55 can be of any suitable configuration and may include a stake 56 that can be partially inserted into the ground or have a wide base for placing onto the ground and a cradle 57 in which cable 12 is placed. Cradle 57 may be semi-cylindrical. Supports 55 can include a stake 56 and a stand 58 into which stake 56 can be inserted. Stand 58 is most useful when the ground under support 55 is hard such as on concrete, patio decking, gravel, etc. Supports 55 may be used because cable 12 is obscured by long grass or similar or to present more of a physical barrier to leaving the enclosed area, particularly when pet P is being trained. Supports 55 are also beneficial when pet P is playing or running quickly inside of the enclosed area; it helps prevent pet P from accidentally crossing cable 12 and receiving a correction by offering a better visual at times that pet P might be distracted.

At either end of antenna cable 12a or 12b are connectors 59 and 60. Connectors 59 and 60 may be male, female of a combination of the two. Any suitable connector may be used for carrying radio signals and electrical current. Alternatively, cable 12a can be permanently connected at one end to base device 14. Generally, connectors 59 and 60 do not match household AC connectors to prevent damage to cable 12 and base device 14.

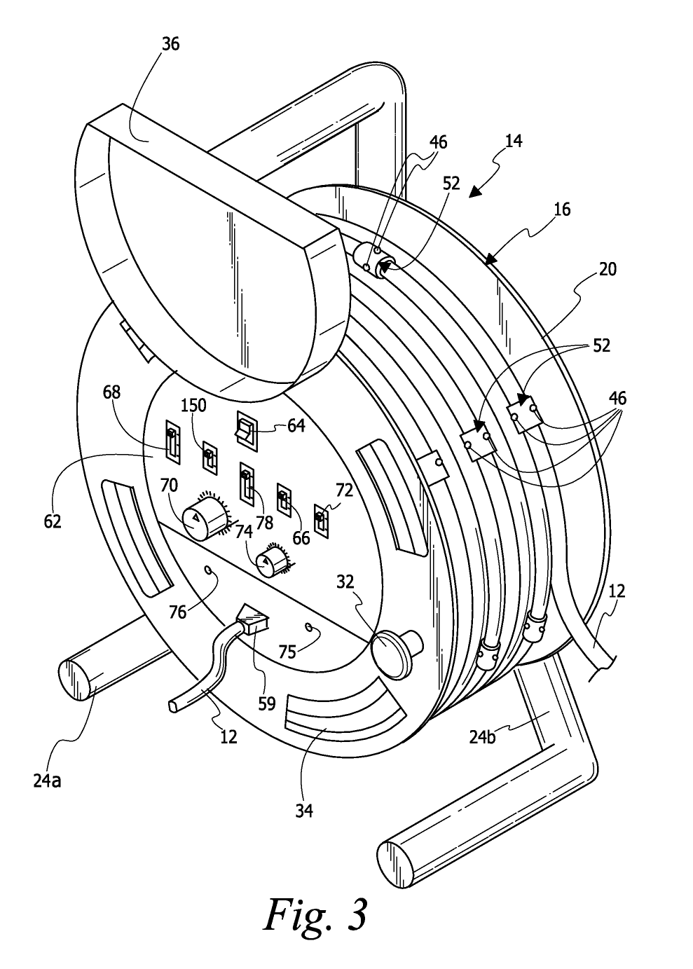

Base device 14 has various user-selectable controls such as switches and knobs. The user-selectable controls may be located on a control panel 62 or elsewhere. Control panel 62 is preferably substantially flush or recessed relative to neighboring reel wall 20 as illustrated in FIG. 3, but can also be raised relative to neighboring reel wall 20. Control panel 62 may have user-selectable controls for turning on the base device such as switch 64 and for controlling lights 46. An on/off switch may be used such as switch 66 to turn the lights on and off. There may be an additional control for the user to select a flashing mode or a steady mode for lights 46. A three-position switch 68 can be used to turn off lights 46 and select the flashing or steady modes instead of having two different switches. In steady mode, lights 46 are on constantly. In flashing mode, lights 46 turn on briefly and then turn off briefly before repeating the automatic on and off cycle. Flashing mode can be beneficial because it saves energy and extends battery life and because it may be more effective in scaring off wildlife and other animals. However, it is generally preferred that flashing mode be reserved for warning or correcting pet P as discussed later. Control panel 62 may also have a knob 70 for controlling the intensity of lights 46.

Control panel 62 may also have any suitable controls. It may have an on/off switch 72 for the transmitter and a knob 74 for controlling the intensity of a signal S (shown schematically in FIG. 5) transmitted by base device 14 through antenna cable 12. Alternatively, knob 74 can be used for turning the transmitter on and controlling the intensity. Turning on and off the transmitter preferably turns on and off lights 46 so that pet P knows when the fence is on and off. Preferably base device 14 has a speaker for playing a warning tone or tones when the fence/transmitter is turned on and for playing a friendlier tone when the fence/transmitter is turned off. Control panel 62 may have a light 75 for indicating that there is a line break in signal conductor 40, and a power light 76.

Base device 14 generally includes a signal generator that generates signal S. The signal generator may be a frequency generator that operates on any suitable frequency, typically a radio frequency. Base device 14 may also have a battery, an AC/DC converter, a transformer for supplying a desired voltage, and a lightning arrester. Light 76 when lit indicates that the device is on. Light 76 when shining green indicates that the battery has a good charge, when shining red indicates that the battery is being charged, when shining yellow indicates the battery has a medium charge, and when flashing red indicates the battery has a low charge. As indicated earlier, base device 14 is preferably mounted to a reel 16. Some or all of base device 14 may be mounted to the interior of reel 16. For example, some portions may be located within core 18. Preferably, the battery and the electrical and electronic components of device 14 are located inside core 18 apart from the user interface of control panel 62 and cable 12.

Control panel 62 also has a frequency control switch 78 for controlling the frequency of signal S to avoid interference with and from other radio signals. Switch 78 can be used to select between 2, 3, or more frequencies. The frequencies may be in the same or different wave bands. Being able to select from 2, 3 or more frequencies can be used to allow stimulation control or the ability to choose the intensity of static correction given to the pet, for example, with 3 frequencies, Low/Medium/High levels of static correction levels are provided, each level corresponding to one of the 3 separate frequencies. Selecting the low, medium or high correction level chooses the frequency produced by the entire antenna wire. The collar typically is configured to receive any of the 3 frequencies and responds according to which signal is received, and then the collar delivers a low, medium or high level of static correction. The collar would not need any exterior adjustment controls, as the collar would receive any of the 3 frequencies.

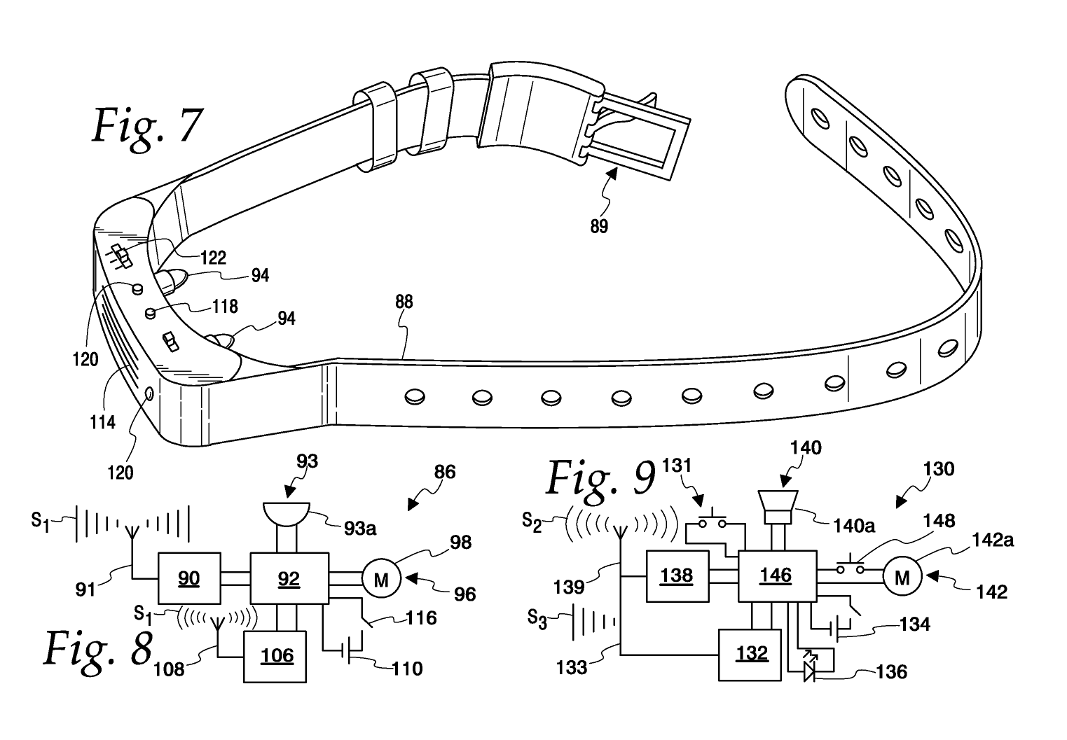

System 10 also includes a portable or receiver (pet-borne) device 84 or 86 that is worn by pet P. The system may include additional portable receiver devices 84 or 86 for additional pets. Preferably, system 10 is compatible with existing portable devices, but existing portable devices do not have all the features of portable device 84 and 86, disclosed herein. Typically, portable receiver devices 84 and 86 are worn by pet P and may be removably attached to an adjustable strap 88. Strap 88 may be adjusted to fit on pet P by a buckle 89 or by hook and loop fasteners such as Velcro®. Strap 88 may be worn around the neck, trunk, leg or other suitable body part of pet P. Portable devices 84 and 86 include a receiver 90 and antenna 91 for receiving signal S (shown schematically in FIG. 8) generated by base device 14, and a warning generator 92. Warning generator 92 issues a first warning to pet P when signal S as received by receiver 90 is at or above a first warning threshold. The first warning can be an audible alarm delivered by a noise generator 93 comprising a speaker or buzzer 93a, a harmless electrical shock or static correction delivered by two electrodes 94, or a vibration delivered by a vibration generator 96. Vibration generator 96 can be of any suitable construction including, for example, a linear resonant actuator or a small electrical motor 98 rotating an eccentric mass. The audible alarm may be ultrasonic such that a person does not hear it, but pet P does. Warning generator 92 is preferably capable of generating two warnings wherein the first warning is an audible warning and a second warning, which is the electrical shock or vibration. The second warning is generated in response to receipt of signal S as received by the receiver is at or above a second warning threshold. The second warning threshold is higher than the first warning threshold. In a preferred embodiment, portable device 84 first provides an audible warning to pet P when pet P approaches cable 12 and second a mild electrical shock if pet P is too close to cable 12 and is used primarily to train pet P to not cross an electronic fence. In a preferred embodiment, portable device 86 has audible warning and vibratory capabilities, but not the static correction capability including electrodes 94, and is used with a pet P that was previously trained to stay within an electronic fence, typically with collar 84.

A third warning may be provided by system 10. Portable receiver devices 84 and 86 may also include a signal generator 106 and a transmitting antenna 108 for generating and transmitting a signal S1 (shown schematically in FIG. 8) to base device 14 via antenna cable 12. Transmitting antenna 108 can be antenna 91 or a separate antenna as illustrated. In either case, base device 14 also has a receiver for receiving signal S1 from portable devices 84 and 86. Signal S1 may be generated at or above a third warning threshold by portable devices 84 and 86. Preferably, the third warning threshold is the same as the first or second warning threshold. Upon receipt of signal S1 from portable device 84 or 86, typically above a third threshold signal strength level, base device 14 may go into a flashing mode for flashing lights 46 to provide a visual warning to pet P when pet P approaches cable 12. The flashing mode automatically terminates once signal S drops below the threshold value when pet P moves sufficiently away from cable 12 or automatically after a brief duration of time such as 2-8 seconds, preferably about 5 seconds. Flashing mode is expected to be particularly helpful for deaf pets. Signal S1 may be different at or above the first and second warning thresholds so that base device 14 goes into a second flashing mode to provide a second visual warning to pet P when pet P approaches cable 12.

During a first, second or third warning, base device 14 may also generate an audible notification so that the owner or guardian of pet P is notified audibly that pet P is receiving a warning or correction and may cross cable 12 exiting the enclosed area, in addition to the visual warning from flashing of lights 46. Signal S1 is generated by warning generator 92 in response to receiving signal S above the first, second or third threshold value. Adjustment of the first, second, and third threshold values is possible, but generally only the strengths of signal S and S1 as transmitted are adjustable as explained above. The intensity of the signal transmitted through the antenna can be adjusted by adjusting the power levels of the transmitter, such as having three power levels to provide a corrective shock at, for example, 1, 2 or 3 feet from the wire or as otherwise desired. A 3-way switch could be used. Also, the signal strength of the static correction signal, the audible and light signals, could be increased with the increase in the power level to the antenna, and all could be controlled by the same switch or selector. Portable devices 84 and 86 may be implemented with electronic circuitry and may include a central processing unit (CPU) with the relevant programming. In particular, warning generator 92 may include a CPU. Signal generators 106 and others not numbered may include a crystal oscillator.

Portable devices 84 and 86 have a battery 110 (disposable or rechargeable) powering portable devices 84 and 86, a grill 114 that covers the speaker or buzzer 93a, an on/off switch 116, a low battery indicator such as LED light 118, and one or more bright locator lights 120. Locator light 120 allows people to locate pet P in low or no light conditions and to alert drivers to pet P along a roadway, such as when pet P is being walked. Locator light 120 has both steady and flashing modes activated by a switch 122 on portable device 84 and 86. Switch 122 may have 3 positions including off or repeated presses of a few seconds each causes the mode to move between off, continuous and flashing.

System 10 may also include a remote monitor 130, preferably wireless. Preferably, remote monitor 130 has control abilities such as an on/off button 131, for turning on and off the electric fence via a signal S2 (shown schematically in FIG. 9) sent by transmitter 132 and antenna 133 of remote monitor 130. Button 131 is similar in function to switch 64 or 72. Remote monitor 130 has a battery 134 (disposable or rechargeable), a light 136, typically LED, for notifying the user when the battery is low, and a receiver 138 connected to an antenna 139 for receiving a signal S3 (shown schematically in FIG. 9) from base device 14 and optionally signal S1 from portable devices 84 and 86. As illustrated in FIG. 9, antennas 133 and 139 are the same, but they need not be. Receiver 138 is operatively connected to a sound generator 140 to produce sounds, to a vibration generator 142 to produce vibrations, or to light 136 to turn it on in response to receipt of signals S3 or S1 by receiver 138 as will be described. Receiver 138 may be operatively connected to one, two or three of sound generator 140, vibration generator 142, and light 136 via electronic circuitry, which may include a CPU 146. Sound generator 140 may include a speaker 140a or buzzer. Vibration generator 142 can be of any suitable construction including a linear resonant actuator or a motor 142a rotating an eccentric mass. Vibration generator 142 may be disabled by a switch 148 to lengthen the life of battery 134.

The operative connection is useful in at least two instances. One, it can notify an owner or guardian of pet P that the pet P is receiving a correction. This notification alerts an owner to the possibility that pet P has left the designated area and that the owner should turn off the transmitter for signal S so that pet P can return to the enclosed area. Two, it can notify the owner or guardian of the location of remote 130. To these ends, receiver 138 may receive signal S1 from signal generator 106 or a signal S3 from base device 14. Signal S3 is optionally generated responsive to base device 14 receiving signal S1 above the third threshold signal strength level. Signal S3 may also be generated by pressing a button 150 on base device 14 to locate remote 130. Receipt by receiver 138 of signal S1 or S3 causes one or more of the following to occur: sound generator 140 emits a sound, tone or tones, vibration generator 142 to vibrate, and light 136 to flash. Signal S3 may include a code indicating whether signal S3 was generated because pet P was too close to cable 12 or because button 150 was pressed. Remote 130 can then provide different audible, vibratory and visual notifications depending on whether pet P was too close to cable 12 or button 150 was pressed.

Signals S, S1, S2 and S3 are typically radio frequency signals, but the signals can be composed of any suitable frequency, modulation, carrier, or method. Because remote 130 can be actively directed by a user toward base device 14, signal S2 from remote 130 to base device 14 can be infrared, for example.

Operation of system 10 will be discussed with reference to FIG. 1. System 10 is installed as in FIG. 1, for example, with pet P near the middle of the area enclosed by cable 12, and includes device 86. When switch 72 is switched to on, base device 14 emits a short warning tone or tones, typically 2-4 seconds in total length, and turns lights 46 on, emitting light continuously. Lights 46 being on and the warning tones indicate to pet P that system 10 is operating and gives pet P a powerful indication of the area that pet P is supposed to stay in. Pet P is wearing a preferred embodiment of portable device 86 attached to a collar 88 around its neck. In the preferred embodiment, device 86 has noise generator 93 and vibration generator 96, but not the static electricity emitter having electrodes 94. Pet P approaches cable 12.

The strength of signal S transmitted by cable 12 received by receiver 90 becomes stronger as pet P approaches cable 12. If pet P continues to approach cable 12, eventually receiver 90 receives signal S at a strength exceeding the first and third warning thresholds (preferably the first and third warning thresholds are the same) and in response, device 86 administers an audible correction to pet P through noise generator 93 and transmits signal S1. Signal S1 is received by device 14 and device 14 flashes lights 46 for 5 seconds or longer if pet P does not move away from cable 12. Signal S1 is also received by remote monitor 130 which sounds a warning tone via sound generator 140 and flashes light 136. If pet P continues to approach cable 12, eventually receiver 90 receives signal S at a strength exceeding the third warning thresholds and in response, device 86 administers a vibratory correction through vibrations generated by vibration generator 142. As the second warning threshold exceeds the third warning threshold, device 86 continues transmitting signal S1 and lights 46 are flashed for 5 seconds or longer if pet P does not move away from cable 12 and remote monitor 130 continues sounding the warning tone and flashing light 136. Optionally, noise generator 93 may continue to issue a warning correction since the first threshold is also being exceeded. When pet P moves away from cable 12 such that the strength of signal S drops below the third warning threshold, portable device 86 ceases to administer vibratory correction, but the other corrections and notifications (flashing lights 46 and 136 and warning tone via sound generator 140) continue and the audible correction from device 86 continues or is renewed. When pet P moves further away from cable 12 such that the strength of signal S drops below the third warning threshold, the various corrections and notifications will cease preferably nearly immediately except that lights 46 may continue flashing for 5 more seconds to urge pet P further away from cable 12. By flashing lights 46, fence system 10 provides an additional correction that reinforces the audible and vibratory corrections and is particularly helpful if pet P is deaf and cannot hear the audible corrections. Flashing lights 46 and notifications from remote 130 alert a user to the possibility that pet P may have left the enclosed area or that some other kind of user intervention may be necessary. If pet P has left the enclosed area, the user can turn off the transmitter and lights 46 by switch 72 of base device 14 or by button 131 of remote 130, which allows pet P to know it can reenter the enclosed area without receiving a correction. Turning off the transmitter and lights 46 also causes base device 14 to emit a tone or tones to signify that the transmitter is off. The tone or tones are preferably different from the warning tone or tones emitted when the transmitter is turned on; preferably the tone or tones are soothing.

Use of a preferred embodiment of system 10 for training a pet P will now be discussed with reference to FIG. 2. System 10 is installed as in FIG. 2, for example, with pet P near the middle of the area enclosed by cable 12. System 10 as shown in FIG. 2, includes portable device 84 instead of portable device 86 and unlike FIG. 1, is shown with cable 12 raised above the ground on supports 55. Supports 55 preferably lift cable 12 approximately 8 inches off the ground making cable 12 more visible particularly if the ground is covered in long grass, for example. In addition, pet P then must make a physical effort to step/jump over cable 12 to leave the enclosed area. Placing cable 12 on supports 55 helps pet P more easily understand that cable 12 is a barrier and is to be respected, leading to faster training.

System 10 can also include a blanket 154 placed in the center of the enclosed area. If pet P becomes anxious or confused, blanket 154 will act as a quick visual to the center of the contained area where pet P will not receive any corrections from system 10. In a preferred embodiment, portable device 84 has noise generator 93 and static electricity emitter including electrodes 94, but not noise generator 93. Operation of portable device 84 is the same as portable device 86 as discussed above, but instead of providing a vibratory correction, it provides a static correction.

Training can include “playing fetch” with a projectile such as a ball or stick thrown to points within the enclosed area and outside. The trainer can stand next to blanket 154 for this kind of training. The trainer can see from observing remote 130 or from flashing lights 46 whether pet P is receiving a correction. Pet P's training can include fetching a projectile thrown to a point outside the enclosed area, but not leaving the area until the pet fence is turned off, i.e., until the transmitter and lights 46 are turned off. Remote 130 can make such training more convenient because it can be used to turn the pet fence off remotely.

When first setting up the device at a new location, teaching the pet to sit and stay on blanket 154 while the pet observes as the trainer lays cable 12 around the perimeter of the containment area may facilitate the pet recognizing the device and learning the trainer's desire to contain the pet in the area.

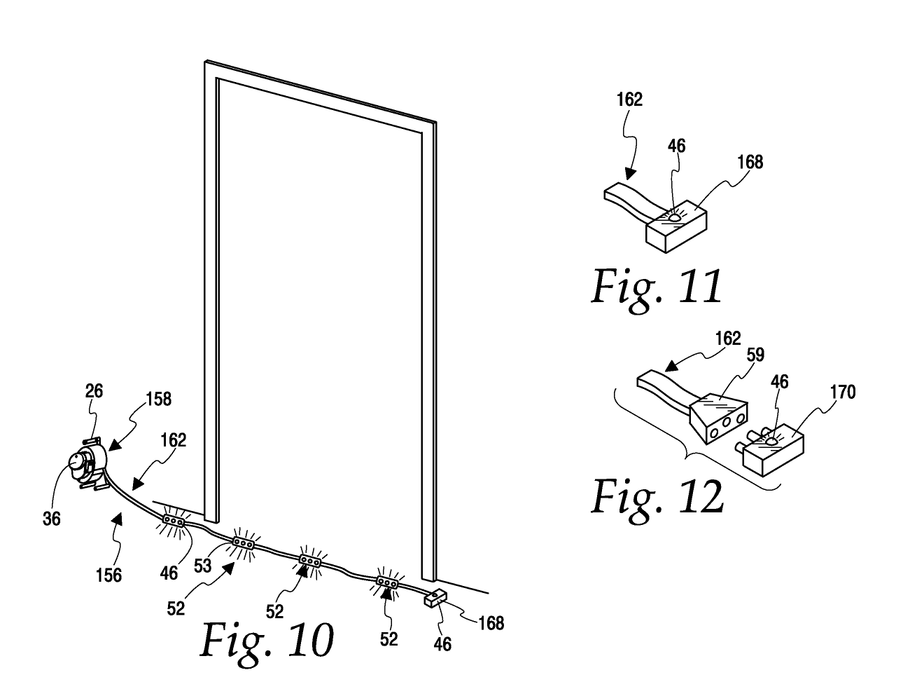

With reference to FIG. 10, a system 156 for use indoors or for virtually blocking doorways is discussed. System 156 can include portable device 84 or 86, a base device 158 and optionally remote 130. Base device 158 is used with an antenna cable 162 as illustrated in FIGS. 10-12. Cable 162 is similar to cable 12. For example, cable 162 can have the same conductors as cable 12, including first conductor 40, second conductor 42, and optionally third conductor 44. Cable 162 may have lights 46, optionally in groups 52. Unlike cable 12, cable 162 only connects to base device 158 at one end, so that it does not form a loop and conductor 40 operates as a monopole antenna rather than a loop antenna. At the end of cable 162 not connected to base device 158, rather than connector 59 or 60, there may be a cable termination device 168 comprising one or more lights 46. Termination device 168 may have a group 52 of lights 46 inside housing 53. Alternatively, the end of cable 162 has connector 59 or 60 plugged into a termination device 170 having a matching connector 60 or 59, respectively. Termination device 170 can have one or more lights 46. Also termination device 170 could be used with cable 12 and cable 12 could be used in the same way as cable 162, particularly when an area is enclosed by a physical fence, but has a wide opening, for example, a driveway. Termination device 168 or 170 may comprise an adjustable resistor to adjust signal strength from the antenna which may be a “dimming” style resistor. This allows the user to “fine tune” the threshold diameters either alone or in addition to the different power settings previously described. Cable 162 is preferably less than 10 feet long, so that cable 162 can span the width of a typical doorway or entrance while allowing base device 158 to be placed out of the way. Cable 162 may be flat as illustrated so that cable 162 lays flatter on the ground. In particular, if the cable has 3 or more conductors, the conductors are arranged along a plane. Lights 46 or groups 52 are preferably spaced about 2 to 12 inches apart. Cable 162 may be configured with or without lights, as can cable 12. Apart from cable 162, base device 158 can be similar or identical to base device 14 except as otherwise indicated. Base device 158 may have an enclosed reel that is self-retracting to retract cable 162. The self-retracting reel can be smaller than reel 16 as cable 162 is shorter than cable 12, and if desired, may be configured without any reel.

System 156 with cable 162 is particularly useful indoors to keep pet P within a certain room or rooms or to exclude pet P from a certain room or rooms. Currently physical pet gates are used for this purpose. System 156 with cable 162 is advantageous over a physical pet gate because (1) it is more portable than conventional pet gates which are bulky if portable or are not easily portable because they are hinged, which requires the hinge or hinges to be attached to a support, (2) is often much easier to set up because they do not have to physically block doorways of different widths or to be mounted, and (3) do not block the doorway to humans requiring the gate to be opened and sometimes removed.

A method of keeping an animal within an enclosed area according to the invention will now be discussed with reference to FIGS. 1, 2 and 10. The method includes enclosing an area (or first area) with an antenna cable. The area to be enclosed can be open or largely open and the enclosing can be an encircling of the area as shown in FIGS. 1 and 2. The enclosing may include plugging in one or both ends of the cable into a transmitter to form a loop as in FIGS. 1 and 2. Alternatively, the area to be enclosed can be partially enclosed by a physical barrier having a passage through the barrier such as an interior space and enclosing the area comprises placing the cable across the passage or doorway as shown in FIG. 10. Typically the antenna cable is wound on a reel for portability and ease of deployment. As the antenna cable encloses the area, it is unwound from the reel. The antenna cable can be deployed under, through or over a barrier such as wooden fence, wall or chain-link fence. Doing so allows the enclosed area to be larger than might otherwise be possible giving the animal a larger area to roam. The enclosed area may include portions that are not readily visible from other portions. For example, as is shown in FIG. 1, the enclosed area encompasses areas on both sides of a wooden fence. Thus an owner of the animal who is on one side of the fence may not be able to see an animal on the other side of the fence. Other aspects of the method allow the owner to remotely monitor the animal as will be discussed subsequently. The antenna cable can also be deployed to enclose objects and obstacles such as a tree or trees, which beneficially may provide shade for the animal. The antenna can also be deployed so that objects are not within the enclosed area, but is adjacent to the object. For example, it may be desirable to have a picnic table, tents, RVs adjacent, but outside the enclosed area. The enclosed area may be remote from the animal owner's home and thus may be used in almost an unlimited number of settings, including, for example, a park, a picnic ground, a campground, and an RV site.

A second part of the method is transmitting a signal through the antenna cable while the animal is in the enclosed area to a receiver carried by the animal.

Typically, the antenna cable includes a plurality of lights and the method includes illuminating the antenna cable with the lights. The method includes placing the animal into the area before, during or after the area has been enclosed. The animal can be deaf in which case illuminating the antenna cable is particularly helpful in keeping the animal within the enclosed area. Normally, the lights are continuously on while the transmitter attached to the antenna cable is transmitting except when the lights are flashed.

The method can include transmitting a second signal from a transmitter carried by the animal and flashing the lights responsive to receipt of the second signal. The transmitter is typically part of a portable device including the receiver that is carried by the animal. The second signal is typically received by a base device that flashes the lights responsive to receipt of the second signal, optionally at a level above a threshold selected to eliminate spurious signals. The second signal may be transmitted from the transmitter carried by the animal responsive to the animal coming too close to the antenna cable. In particular, the second signal is transmitted responsive to the receiver of the portable device receiving the first signal above a first signal threshold.

In addition to transmitting the second signal, the portable device can generate warnings or corrections to the animal in the form of audible corrections like warning tones, static electricity corrections and vibratory corrections when the portable device receives the first signal above a second, third or fourth warning threshold. The first, second, third and fourth warning thresholds may be the same or different as suitable.

Providing one or more additional notifications to the owner or guardian of the animal that the animal is too close to the antenna or may have left the enclosed area by a remote monitor can also be part of the method. The one or more notifications may be a blinking light on the remote monitor, vibrating the remote monitor, or making an audible notification by the remote monitor. The notifications may be made in response to the remote monitor receiving the second signal, optionally above a threshold selected to eliminate spurious notifications. Alternatively, the base device may transmit a third signal responsive to receipt of the second signal, optionally at a level above a threshold selected to eliminate spurious signals, and the notifications are provided responsive to the remote monitors receipt of the third signal, optionally above a threshold selected to eliminate spurious notifications.

The method can also include placing a plurality of supports around the area and placing the antenna cable onto the supports for raising the antenna cable off the ground during the enclosing as shown in FIG. 2. Advantageously, the method can also include training the animal to stay within the area enclosed by the antenna cable on the supports.

The method of the invention is advantageous because of the ability to practice it at different locations. In particular, the method can also include enclosing a second area with the antenna cable and transmitting a signal through the antenna cable while the animal is in the second enclosed area. The method can further include winding the antenna cable onto a reel with a transmitter for transmitting the signal mounted to the reel. Then the reel is carried with the antenna cable wound around it from the second area to the first area and the cable is unwound from the reel during the enclosing of the first area.

### EXAMPLE

A working embodiment of the system was built. It had an antenna cable having 3 conductors, one for the antenna, one for positive and one for negative with a yellow-colored insulating sheath on the exterior of the antenna. The cable had groups of three LED lights regularly spaced along the cable about every two feet. The cable was approximately 25 feet long. Within each group, both LED lights were wired in parallel to a 270 Ω½ watt resistor, which was connected to the positive conductor, and to the negative conductor. The LED lights were Alpena 5053 LEDs. The cable was connected to a conventional pet fence device attached to a reel having a stand similar to the base device illustrated in FIG. 3 and to a 12V battery for power for the lights. The working embodiment was successfully tested with a pet wearing a conventional pet fence collar.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims.

I claim:

1. A portable electronic fence system for enclosing an area to prevent an animal carrying a signal receiver from entering or leaving the area, the signal receiver providing a warning to the animal when the animal is too close to the electronic fence, the fence system comprising:
an antenna cable for enclosing the area, the antenna having a length and a plurality of lights spaced along the length; and
a transmitter for transmitting a signal to the receiver through the antenna.

2. The fence system of claim 1 further comprising a carrier including an antenna cable storage reel, the transmitter mounted to the carrier.

3. The fence system of claim 2 wherein the antenna cable storage reel comprises a core and a shaft around which the reel core can be rotated for winding the antenna cable around the core.

4. The fence system of claim 1 further comprising a flashing mode control wherein the plurality of lights are flashed by operation of the flashing mode control.

5. The fence system of claim 4 further comprising a portable device having the receiver and a second transmitter for transmitting a second signal for activating the flashing mode control.

6. The fence system of claim 5 further comprising a base device having the transmitter and a second receiver for receiving the second signal.

7. The fence system of claim 6 further comprising a remote control having a transmitter for transmitting a signal to the base device to turn off the transmitter, a third receiver for receiving the second signal, and an indicator for making an indication that the animal has received a warning, the indicator operatively connected to the receiver to make the indication responsive to the receipt of the second signal by the receiver.

8. The fence system of claim 1 wherein the antenna cable comprises a power conductor for supplying power to the lights and a signal conductor for transmitting the signal.

9. The fence system of claim 1 further comprising the signal receiver.

10. A portable electronic fence system for enclosing in an area an animal carrying a signal receiver, the receiver providing a warning to the animal when the animal is too close to the electronic fence, the fence system comprising:
an antenna cable for enclosing the area;
a transmitter for transmitting a signal to the receiver through the antenna; and
a carrier for the antenna cable, the carrier including an antenna cable storage reel, the transmitter mounted to the carrier.

11. The fence system of claim 10 wherein the reel comprises a core and a shaft around which the reel can be rotated for winding the antenna cable around the core.

12. The fence system of claim 10 further comprising a battery for supplying electricity to the transmitter, the battery mounted to the carrier.

13. A portable device for attaching to an animal and keeping the animal either within or outside of an area enclosed by an antenna cable connected to a base unit, the portable device comprising:
a receiver for receiving a first signal transmitted by the antenna cable;
a warning generator for issuing a first warning to the animal when the first signal received by the receiver meets or exceeds a first threshold; and
a transmitter for transmitting a second signal to the antenna cable for triggering a second warning to the animal by the base unit, wherein the second signal is transmitted responsively to the receipt of the first signal at or above a second threshold.

14. The portable device of claim 13 wherein the first warning issued in response to receipt of the first signal above the first threshold is an audible warning, an electric shock, or a vibration.

15. The portable device of claim 13 further comprising an adjustable strap for attaching the portable device to an animal.

16. The portable device of claim 13 further comprising a light, the light lighting in response to receipt of the first signal by the receiver above a third threshold, for making the animal easier to locate.

17. The portable device of claim 13 wherein the warning generator generates a third warning in response to receipt of the first signal by the receiver above a third threshold, the third warning being an electric shock or a vibration.

18. A method of keeping an animal either within or outside of an enclosed area, the method comprising:
enclosing an area with an antenna cable including a plurality of lights;
transmitting a signal through the antenna cable while the animal is in the enclosed area to a receiver carried by the animal; and
illuminating the antenna cable with the lights.

19. The method of claim 18 further comprising placing the animal into the area, the animal being deaf.

20. The method of claim 18 further comprising transmitting a second signal from a transmitter carried by the animal and flashing the lights responsive to receipt of the second signal above a threshold.

21. The method of claim 20 further comprising lighting the lights continuously while transmitting the signal except when flashing the lights.

22. The method of claim 18 wherein enclosing the area comprises unwinding the antenna cable from a reel.

23. The method of claim 22 further comprising, prior to the enclosing the area, carrying the reel to the area, the antenna cable being wound around the reel during the carrying.

24. The method of claim 18 further comprising:
enclosing a second area with the antenna cable; and
transmitting the signal through the antenna cable while the animal is in the second enclosed area.

25. The method of claim 24 wherein the area is a first area, the method further comprising:
winding the antenna cable onto a reel, a transmitter for transmitting the signal mounted to the reel;
carrying the reel with the antenna cable wound around the reel from the first area to the second area; and
unwinding the antenna cable from the reel during the enclosing of the second area.

26. The method of claim 18 further comprising placing a plurality of supports around the area and placing the antenna cable onto the supports for raising the antenna cable off the ground during the enclosing.

27. The method of claim 26 further comprising training the animal to stay within the enclosed area.

28. The method of claim 18 wherein the area is partially enclosed by a physical barrier having a passage through the barrier and enclosing the area comprises placing the cable across the passage.

29. A method of keeping an animal either within or outside of a room having an open doorway comprising:
laying an antenna cable across the doorway, and
transmitting a signal through the antenna cable while the animal is in the enclosed area to a receiver carried by the animal.

30. The method of claim 29 further comprising before said activating, placing the animal outside of the room if it is desired to keep the animal outside of the room.

31. The method of claim 29 further comprising before said activating, placing the animal within the room if it is desired to keep the animal outside the room.
